(19) United States
(12) Patent Application Publication
(10) Pub. No.: US 2015/0049259 A1
(43) Pub. Date: Feb. 19, 2015

(54) TOUCH SENSOR MODULE AND MANUFACTURING METHOD THEREOF

(71) Applicant: SAMSUNG ELECTRO-MECHANICS CO., LTD., Suwon-si (KR)

(72) Inventors: Beom Seok Oh, Suwon-si (KR); Tae Kyung Lee, Suwon-si (KR)

(73) Assignee: SAMSUNG ELECTRO-MECHANICS CO., LTD., Suwon-si (KR)

(21) Appl. No.: 14/169,567

(22) Filed: Jan. 31, 2014

(30) Foreign Application Priority Data
Aug. 13, 2013 (KR) 10-2013-0095876

(51) Int. Cl. G06F 3/041; B32B 37/00; B32B 38/00; B32B 37/24

(52) U.S. Cl. CPC G06F 3/041; B32B 37/24; B32B 37/0038; B32B 38/145; B32B 2037/243; B32B 2307/412; B32B 2307/202; B32B 2457/208
USPC 349/12; 156/277

(57) ABSTRACT

Disclosed herein is a touch sensor module, including: a window substrate; a bezel layer including at least one print layer along an edge in a direction facing the window substrate; and an application layer formed to enclose a surface of the print layer while being applied to the surface of the print layer.

### CROSS REFERENCE TO RELATED APPLICATION

This application claims the benefit of Korean Patent Application No. 10-2013-0095876, filed on Aug. 13, 2013, entitled “Touch Sensor Module and Manufacturing Method Thereof”, which is hereby incorporated by reference in its entirety into this application.

### BACKGROUND OF THE INVENTION

1. Technical Field

The present invention relates to a touch sensor module and a manufacturing method thereof.

2. Description of the Related Art

In accordance with the growth of computers using a digital technology, devices assisting the computers have also been developed, and personal computers, portable transmitters, other personal information processors, and the like execute processing of text and graphics using a variety of input devices such as a keyboard and a mouse.

In accordance with the rapid advancement of an information-oriented society, the use of computers has gradually been widened; however, it is difficult to efficiently operate products using only the keyboard and the mouse currently serving as an input device. Therefore, the necessity for a device that is simple, has minimum malfunction, and is capable of easily inputting information has increased.

In addition, techniques for input devices have progressed toward techniques related to high reliability, durability, innovation, designing and processing beyond the level of satisfying general functions. To this end, a touch sensor has been developed as an input device capable of inputting information such as text, graphics, or the like.

This touch sensor is mounted on a display surface of a display such as an electronic organizer, a flat panel display device including a liquid crystal display (LCD) device, a plasma display panel (PDP), an electroluminescence (El) element, or the like, or a cathode ray tube (CRT) to thereby be used to allow a user to select desired information while viewing the display.

In addition, the touch sensor is classified into a resistive type, a capacitive type, an electromagnetic type, a surface acoustic wave (SAW) type, and an infrared type.

These various types of touch sensors are adapted for electronic products in consideration of a signal amplification problem, a resolution difference, a level of difficulty of designing and processing technologies, optical characteristics, electrical characteristics, mechanical characteristics, resistance to an environment, input characteristics, durability, and economic efficiency. Currently, the resistive type touch sensor and the capacitive type touch sensor have been prominently used in a wide range of fields.

In a typical touch sensor, as described in Korean Patent Laid-Open Publication No. 10-2013-0017898, a structure of a bezel (inactive region) part formed on an edge has an application layer formed by applying a material such as ink onto several layers of a bezel layer. This application layer may degrade adhesion and bonding force while a thickness thereof is relatively increased in order to secure shielding force in a case a bright color rather than a dark color.

### PRIOR ART DOCUMENT

### Patent Document

(Patent Document 1) KR10-2013-0017898 A

### SUMMARY OF THE INVENTION

The present invention has been made in an effort to provide a touch sensor module capable of securing shielding force of a bezel portion and improving adhesion between a touch sensor and an application layer.

According to a preferred embodiment of the present invention, there is provided a touch sensor module, including: a window substrate; a bezel layer including at least one print layer along an edge in a direction facing the window substrate; and an application layer formed to enclose a surface of the print layer while being applied to the surface of the print layer.

The print layer and the application may have a color brightness value B of 50 or more.

The print layer and the application layer may be formed using the same material and brightness.

A display part having the brightness less than that of the application layer and the print layer may be further formed on a surface of the application layer.

The print layer may include: a first print layer applied in a stacked direction while contacting the window substrate; and a second print layer stacked with at least one layer on an upper end portion of the first print layer to thereby be applied thereto.

The second print layer may be stacked on the surface of the first print layer to be formed by a step scheme.

The application layer may be formed to have a gentle curve so that it encloses the first print layer and the second print layer.

According to another preferred embodiment of the present invention, there is provided a touch sensor module, including: a bezel layer including at least one print layer along an edge in a direction facing the window substrate; an application layer applied onto a surface of the print layer; and a base substrate formed to face the window substrate, disposed at a lower end portion of the application layer and having an electrode pattern formed thereon.

The print layer and the application layer may have a color brightness value B of 50 or more.

The print layer and the application layer may be formed using the same material and brightness.

A display part having the brightness less than that of the application layer and the print layer may be further formed on a surface of the application layer.

The print layer includes: a first print layer applied in a stacked direction while contacting the window substrate; and a second print layer stacked with at least one layer on an upper end portion of the first print layer to thereby be applied thereto.

The second print layer may be stacked on the surface of the first print layer to be formed by a step scheme.

The application layer may be formed to have a gentle curve so that it encloses the first print layer and the second print layer.

The application layer may be formed to have an area enclosing the print layer wider than the print layer.

According to still another preferred embodiment of the present invention, there is provided a manufacturing method of a touch sensor module, the method including: preparing a window substrate; forming a print layer on one surface of the window substrate along an edge to form a bezel; forming an application layer applied onto a surface of the print layer; and coupling the window substrate and a base substrate having an electrode pattern formed thereon to each other.

The forming of the print layer may include: forming a first print layer applied to a stacked direction while contacting the window substrate; and forming a second print layer stacked with at least one layer on an upper end portion of the first print layer to thereby be applied thereto by a step scheme.

In the forming of the application layer, the application layer may be formed to have a gentle curve while enclosing the first print layer and the second print layer.

After the forming of the application layer, a display part having the brightness less than that of the application layer and the first print layer may be further formed on an upper end portion of a surface of the application layer.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view of a touch sensor module according to a preferred embodiment of the present invention;

FIG. 2 is a view illustrating an application layer enclosing a print layer according to a preferred embodiment of the present invention;

FIG. 3 is a view illustrating a first modification of the application layer enclosing the print layer of FIG. 2; and

FIGS. 4 to 7 are process sequence views of the touch sensor module according to a preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the accompanying drawings.

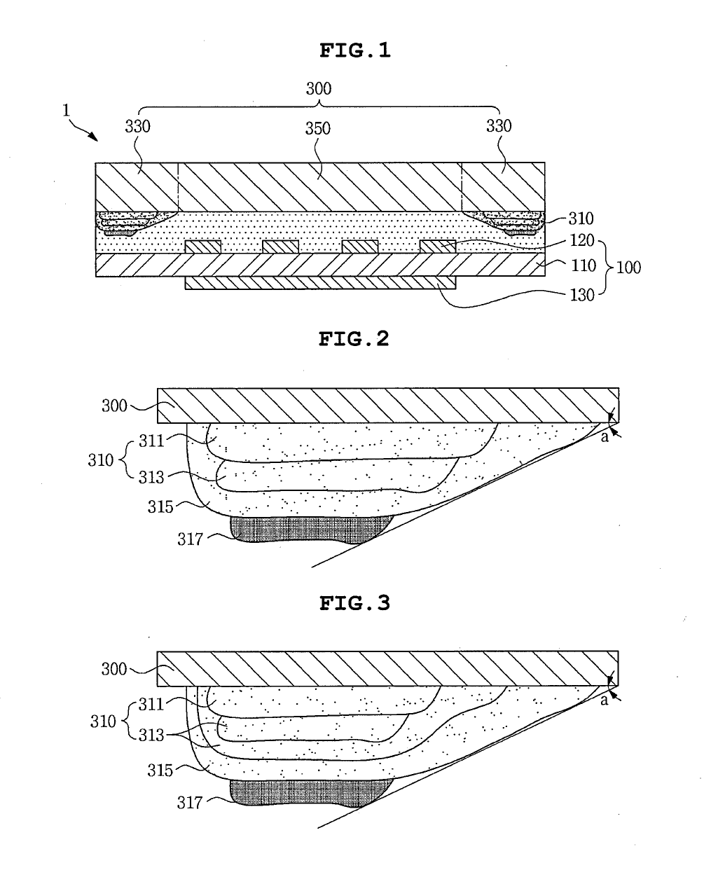

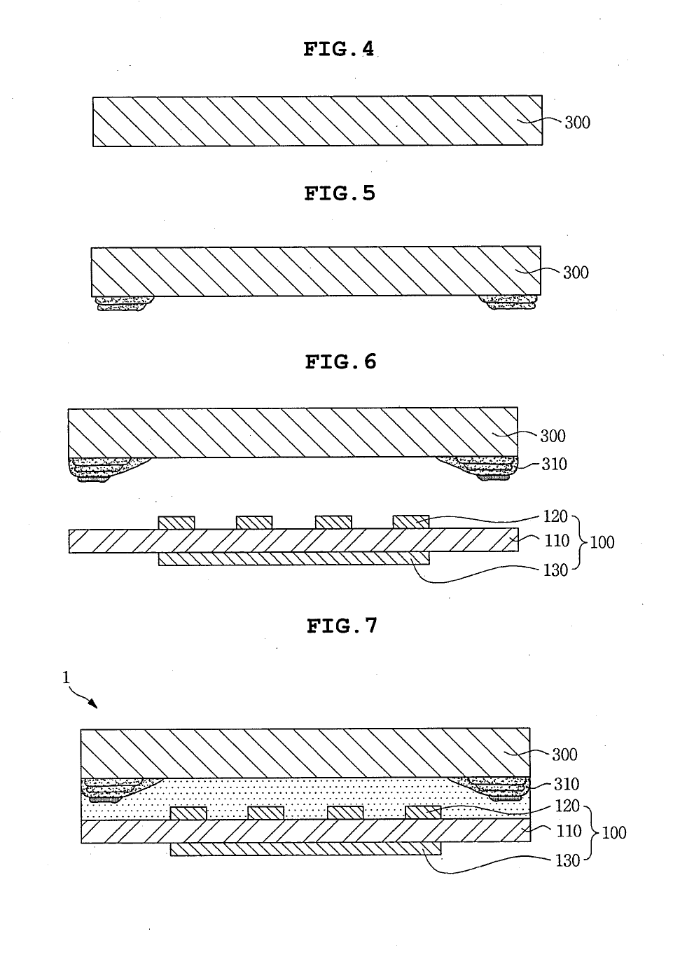

FIG. 1 is a cross-sectional view of a touch sensor module according to a preferred embodiment of the present invention, FIG. 2 is a view illustrating an application layer enclosing a print layer according to a preferred embodiment of the present invention, FIG. 3 is a view illustrating a first modification of the application layer enclosing the print layer of FIG. 2, and FIGS. 4 to 7 are process sequence views of the touch sensor module according to a preferred embodiment of the present invention.

A term ‘touch’ used throughout the present specification is to broadly be construed to mean that an input unit directly contacts with a contact reception surface and the input unit has come close to the contact reception surface by a significant distance.

According to the preferred embodiment of the present invention, electrode patterns 120 and 130 are formed on both side surfaces of a base substrate 110. This is not to limit the electrode patterns of the base substrate 110 to a double-side.

Referring to FIG. 1, a touch sensor module 1 according to the preferred embodiment of the present invention is configured to include a window substrate 300, a bezel layer 310 having one or more print layers 311 and 313 along an edge in a direction facing the window substrate 300, and an application layer 315 formed to be applied onto surfaces of the print layers 311 and 313 to thereby enclose the surfaces of the print layers 311 and 313.

The window substrate 300 may serve to provide a region on which the electrode patterns 120 and 130 for detecting a touch position are formed. The window substrate 300 needs to have support force capable of supporting the electrode patterns 120 and 130 and transparency capable of allowing a user to recognize an image provided by an image display device. The window substrate 300 is formed at the outermost portion of the touch sensor 100 in a direction to which a touch of the user is input, and may serve as a protection layer protecting the touch sensor 100 by using tempered glass having a predetermined strength or more, or the like.

The touch sensor 100 according to the preferred embodiment of the present invention includes the base substrate 110, and the first electrode pattern 120 and the second electrode pattern 130 each formed on both sides of the base substrate 110.

The base substrate 110 serves to provide a region on which the electrode patterns 120 and 130 and an electrode wiring (not shown) are to be formed. Here, the base substrate 110 is partitioned into an active region 350 and the bezel region 330, where the active region 350, which is a portion in which the electrode patterns 120 and 130 are formed so as to recognize the touch of the input unit, is provided to the center of the base substrate 110 and the bezel region 330, which is a portion in which the electrode wiring (not shown) extended from the electrode patterns 120 and 130 is formed, is provided to the edge of the active region 350. In this case, the base substrate 110 needs to have support force capable of supporting the electrode patterns 120 and 130 and the electrode wiring (not shown) and transparency capable of allowing the user to recognize the image provided by the image display device. In consideration of the support force and the transparency, the base substrate 110 may be made of polyethyleneterephthalate (PET), polycarbonate (PC), polymethylmethacrylate (PMMA), polyethylenenaphthalate (PEN), polyethersulfone (PES), cyclic olefin copolymer (COC), triacetylcellulose (TAC) film, polyvinyl alcohol (PVA) film, polyimide (PI) film, polystyrene (PS), biaxially oriented polystyrene (BOPS; containing K resin), glass or tempered glass, or the like, but is not necessarily limited thereto.

The electrode patterns 120 and 130, which serve to generate a signal at the time of touch by the input unit to allow a controller to recognize a touch coordinate, are formed on the base substrate 110. According to the preferred embodiment of the present invention, an electrode pattern formed in an X axis direction of the base substrate 110 is designated as the first electrode pattern 120 and an electrode pattern formed in a Y axis direction of the base substrate 110 is designated as the second electrode pattern 130.

The present invention is to make a thickness of the bezel layer 310 of the touch sensor module 1 thin and to improve adhesion between the base substrate 110 and the window substrate 300. Thereby, operational reliability may be maintained and products to which the touch sensor module 1 reflecting user convenience and preference is applied may be diversified.

The touch sensor module 1 includes the bezel layer 310 having one or more print layers 311 and 313 along the edge in a direction facing the window substrate 300, and the application layer 315 formed to be applied on the surfaces of the print layers 311 and 313 to thereby enclose the surfaces of the print layers 311 and 313.

The bezel layer 310 serves to cover one surface of a wiring electrode (not shown) disposed on region corresponding to the bezel region 330 of the base substrate 110. In addition, the bezel layer 310 may have a decoration pattern such as a manufacturer logo, if necessary. The bezel layer 310 has the print layers 311 and 313 formed by stacking one or more layers along the edge of the window substrate 300. The print layers 311 and 313 are formed on the bezel region 330 of one surface of the window substrate 300. The print layers 311 and 313 are formed in a multi-layer by repeatedly stacking several print layers in order to secure shielding force in a case of a bright color. This is to secure the shielding force.

Generally, when representing brightness B in a range of 0 through 100, in the case in which a brightness (B) value approaches 0 (B=0), it is represented that the brightness is ‘dark’ and in the case in which the brightness (B) value approaches 100 (B=100), it is represented that the brightness is ‘bright’. This means that the print layer is repeatedly stacked in order to secure the shielding force in the case in which the brightness value is 100 (B=100) while the shielding force may be secured by only a thin layer in the case in which the brightness value is 0 (B=0).

According to the preferred embodiment of the present invention, it is advantageous that the print layers 311 and 313 are used with the brightness (B) value of 50 or more. This is to secure the shielding force while having the thin thickness using a bright series of colors, which is characteristic of the present invention by sequentially stacking the first print layer 311 and the second print layer 313.

The bezel layer 310 includes the first print layer 311 applied in a stacking direction while contacting the window substrate 300 and the second print layer 313 stacked with at least one layer on an upper end portion of the first print layer 311 to thereby be applied thereto.

The first print layer 311 is formed so as to prevent an inside of the window substrate 300 from being viewed from the outside. It is advantageous that the print layer 311 has the brightness (B) value of 50 or more so as to have the bright series of colors.

The second print layer 313 is stacked and formed on a surface of the first print layer 311. The second print layer 313 is formed so as to be smaller than a width of the first print layer 311. In this case, a plurality of second print layers 313 are stacked and formed over the first print layer 311 so as to have a predetermined slope.

The plurality of second print layers 313 are stacked and formed on the upper end portion of the first print layer 311, thereby improving shielding property. That is, the first print layer 311 and the second print layer 313 are stacked in a step shape, such that at least one layer is formed to be thin, thereby having the shielding property. It is advantageous that the second print layer 313 uses the same material as that of the first print layer 311.

Referring to FIG. 2, the application layer 315 is formed to enclose the print layers 311 and 313 without departing from the bezel region 330 of the base substrate 110. It is advantageous that the application layer 315 uses the same material as that of the first print layer 311. That is, the application layer 315 has the same brightness (B) value as the first print layer 311. The application layer 315 is formed while covering surfaces of the first print layer 311 and the second print layer 313. In this case the application layer 315 removes air trap generated at the time of stacking the second print layer 313 on the surface of the first print layer 311.

The application layer 315 is formed to have the slope gradually lowering toward a direction of the active region 350 of the base substrate 110. That is, the application layer 315 is formed to have a gentle slope while the first print layer 311 and the second print layer 313 are applied. This is to prevent the adhesion from being degraded by a step generated at each layer when the first print layer 311 and the second print layer 313 are stacked by a step scheme.

The application layer 315 is formed so that an angle a between one surface of the base substrate 110 and a slope surface of the bezel 310 is 90° or less (see FIG. 2). An angle a between the window substrate 300 and a slope surface of the application layer 315 may be formed to be 10° to 80°. This is to gently couple an adhesive 200 when the application layer 315 is adhered to the touch sensor. In this case, the application layer 315 uses a material having viscosity so as to enclose the print layers 311 and 313 and maintain the slope angle. The application layer 315 may use a bezel composition including silane, a coloring agent, and a binder resin. Further, the bezel composition may further contain a photopolymerizable compound, a photopolymerizable initiator, a solvent, and an additive. The silane may be made of RSi(OCNH2NH)3, for example, vinyltriethoxysilane. The coloring agent may be made of a coloring agent composition including pigment and pigment propellant. A display layer 317 may be formed on the upper end portion of the surface of the application layer 315 using a material having the same brightness value as or less than that of the first print layer 311. A wiring connecting an electrical signal to the outside may be formed on one surface of the display layer 317.

In a touch sensor module according to a first modified example of the application layer enclosing the print layers, the second print layer 313 may be stacked and formed by various schemes rather than the step scheme with the first print layer 311, as shown in FIG. 3. The second layer 313 and the first print layer 311 may have different materials and different brightness. This is not to limit the material of the second print layer 313 and the first print layer 311.

FIG. 4 is a view showing an operation of preparing the window substrate 300. The window substrate 300 may appropriately use a transparent material for visibility of the touch sensor module 1. Since the description of the window substrate 300, the base substrate 110, and the electrode patterns 120 and 130 has made in the touch sensor module 1 according to the embodiment of the present invention, an overlapped description thereof will be omitted.

FIG. 5 is a view showing an operation of forming the first print layer 311 and the second print layer 313 along the edge of the window substrate 300. Here, the first print layer 311 and the second print layer 313 may be formed by a dry process, a wet process, or a direct patterning process. Here, the dry process includes sputtering, evaporation, or the like, the wet process includes dip coating, spin coating, roll coating, spray coating, or the like, and the direct patterning process includes screen printing, gravure printing, inkjet printing, or the like. The first print layer 311 and the second print layer 313 are stacked and formed by the step scheme.

FIG. 6 shows an operation of forming the application layer 315 on the surfaces of the print layers 311 and 313. When a plurality of the first and second print layers 311 and 313 described above are formed by the step scheme, the application layer 315 is applied to enclose the first print layer 311 and the second print layer 313. In this case, the application layer 315 has a slope of a gentle curve having a height gradually lowering toward a direction of the active region 350. This may improve the adhesion when the window substrate 300 and the touch sensor 100 are coupled.

The display layer 317 preventing the inside from being viewing from the outside may be formed on the upper end portion of the application layer 315. A wiring transmitting the electrical signal of the electrode patterns 120 and 130 may be formed on one surface of the display layer 317 to thereby be used to serve as a path. It is advantageous that the display layer 317 uses a material having the brightness value less than that of the first print layer 311. This is to shield the inside so as not to be viewed from the outside. In addition, the first print layer 311 and the application layer 315 use the material having the brightness value of 50 or more and are repeatedly stacked, thereby allowing the first print layer 311 and the application layer 315 to have the shielding force.

The first electrode pattern 120 and the second electrode pattern 130 are formed on both surfaces of the base substrate 110. FIG. 7 shows an operation of coupling the window substrate 300 and the base substrate 110 to each other. The edge of the base substrate 110 is adhered to the window substrate 300 using an adhesive layer 200, such that the first electrode pattern 120 is disposed to face the window substrate 300. Here, the adhesive layer 200 may use an optical clear adhesive (OCA) or a double adhesive tape (DAT), but is not particularly limited thereto.

According to the preferred embodiment of the present invention, the application layer enclosing the print layer is formed, such that the adhesion between the window substrate and the touch sensor is improved, thereby making it possible to improve electrical reliability.

Further, the application layer enclosing the print layer is formed, such that air trap occurrence caused when sequentially stacking the first print layer and the second print layer is decreased, thereby making it possible to improve reliability of the product.

Further, the application layer enclosing the print layer is formed, such that a tapered angle caused when sequentially stacking the first print layer and the second print layer may be decreased.

Further, the application layer enclosing the print layer, such that the thickness of the print layer stacked to secure the shield force in the case of the bright color including the white color may become thin.

Further, the application layer enclosing the print layer, such that the thickness of the bezel layer may become thin and the thickness of the touch sensor product may be decreased.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch sensor module, comprising:
a window substrate;
a bezel layer including at least one print layer along an edge in a direction facing the window substrate; and
an application layer formed to enclose a surface of the print layer while being applied to the surface of the print layer.

2. The touch sensor module as set forth in claim 1, wherein the print layer and the application have a color brightness value of 50 or more.

3. The touch sensor module as set forth in claim 1, wherein the print layer and the application layer are formed using the same material and brightness.

4. The touch sensor module as set forth in claim 3, wherein a display part having the brightness less than that of the application layer and the print layer is further formed on a surface of the application layer.

5. The touch sensor module as set forth in claim 1, wherein the print layer includes:
a first print layer applied in a stacked direction while contacting the window substrate; and
a second print layer stacked with at least one layer on an upper end portion of the first print layer to thereby be applied thereto.

6. The touch sensor module as set forth in claim 5, wherein the second print layer is stacked on the surface of the first print layer to be formed by a step scheme.

7. The touch sensor module as set forth in claim 5, wherein the application layer is formed to have a gentle curve so that it encloses the first print layer and the second print layer.

8. A touch sensor module, comprising:
a window substrate;
a bezel layer including at least one print layer along an edge in a direction facing the window substrate;
an application layer applied onto a surface of the print layer; and
a base substrate formed to face the window substrate, disposed at a lower end portion of the application layer and having an electrode pattern formed thereon.

9. The touch sensor module as set forth in claim 8, wherein the print layer and the application layer have a color brightness value of 50 or more.

10. The touch sensor module as set forth in claim 8, wherein the print layer and the application layer are formed using the same material and brightness.

11. The touch sensor module as set forth in claim 10, wherein a display part having the brightness less than that of the application layer and the print layer is further formed on a surface of the application layer.

12. The touch sensor module as set forth in claim 8, wherein the print layer includes:
a first print layer applied in a stacked direction while contacting the window substrate; and
a second print layer stacked with at least one layer on an upper end portion of the first print layer to thereby be applied thereto.

13. The touch sensor module as set forth in claim 12, wherein the second print layer is stacked on the surface of the first print layer to be formed by a step scheme.

14. The touch sensor module as set forth in claim 12, wherein the application layer is formed to have a gentle curve so that it encloses the first print layer and the second print layer.

15. The touch sensor module as set forth in claim 12, wherein the application layer is formed to have an area enclosing the print layer wider than the print layer.

16. A manufacturing method of a touch sensor module, the method comprising:
preparing a window substrate;
forming a print layer on one surface of the window substrate along an edge to form a bezel;
forming an application layer applied onto a surface of the print layer; and
coupling the window substrate and a base substrate having an electrode pattern formed thereon to each other.

17. The method as set forth in claim 16, wherein the forming of the print layer includes:
forming a first print layer applied to a stacked direction while contacting the window substrate; and
forming a second print layer stacked with at least one layer on an upper end portion of the first print layer to thereby be applied thereto by a step scheme.

18. The method as set forth in claim 17, wherein in the forming of the application layer, the application layer is formed to have a gentle curve while enclosing the first print layer and the second print layer.

19. The method as set forth in claim 18, wherein after the forming of the application layer, a display part having the brightness less than that of the application layer and the first print layer is further formed on an upper end portion of a surface of the application layer.
